(19) United States
(12) Patent Application Publication
(10) Pub. No.: US 2017/0368708 A1
(43) Pub. Date: Dec. 28, 2017

(54) APPARATUS WITH TOOLS CAPABLE OF SIMULTANEOUSLY MODIFYING A SUBSTRATE

(71) Applicant: American Crafts, LC, Orem, UT (US)

(72) Inventors: James H. Kelly, Cleveland, TX (US); Aaron J. Pichon, Houston, TX (US)

(21) Appl. No.: 15/630,825

(22) Filed: Jun. 22, 2017

Related U.S. Application Data
(60) Provisional application No. 62/326,160, filed on Apr. 22, 2016.
(60) Provisional application No. 62/488,761, filed on Apr. 22, 2017.

(51) Int. Cl. B26D 7/20; B26D 3/08; B26D 7/01; B43K 23/00; B26D 7/00

(52) U.S. Cl. CPC B26D 7/20; B26D 7/015; B43K 23/001; B26D 3/085; B26D 2007/0093; B26D 2007/0068

(57) ABSTRACT

An apparatus for modifying a sheet of a material (e.g., paper, cardstock, a plastic film, foil, fabric, etc.), or a substrate, includes a base, a handle and a plurality of tools held by the handle. The tools may be removably secured to the handle, and may be arranged in a variety of different ways. Each tool is capable of interacting with the substrate in a manner that will modify (e.g., cut, score, perforate, mark, etc.) the substrate. The handle is capable of being translated, or moved, at least partially across the substrate and of causing the tools to concurrently interact with and modify a plurality of laterally discrete, a substantially linear, substantially parallel locations of the substrate as the handle is translated at least partially across the substrate. Modular tools that may be used with an apparatus that holds a plurality of tools or with hand-held handles are also disclosed, as are methods for simultaneously modifying a plurality of laterally discrete, a substantially linear, substantially parallel locations of a substrate.

### CROSS-REFERENCE TO RELATED APPLICATIONS

A claim for priority is hereby made pursuant to 35 U.S.C. §119(e) to the Apr. 22, 2016 filing date of U.S. Provisional Patent Application 62/326,160, titled INTEGRATED DEVICE AND METHOD FOR SIMULTANEOUSLY CREATING MULTIPLE SCORES, MARKS OR CUTS (“the '160 Provisional Application”). A claim for priority is also made pursuant to 35 U.S.C. §119(e) to the Apr. 22, 2017 filing date of U.S. Provisional Patent Application 62/488,761, titled INTEGRATED DEVICE AND METHOD FOR SIMULTANEOUSLY CREATING MULTIPLE SCORES, MARKS OR CUTS (“the '761 Provisional Application”). The entire disclosures of both the '160 Provisional Application and the '761 Provisional Application are hereby incorporated herein.

### TECHNICAL FIELD

This disclosure relates generally to apparatuses for cutting and/or trimming a substrate, such as those generally referred to as “paper trimmers.” More specifically, this disclosure relates to apparatuses that are capable of simultaneously modifying (e.g., cutting, scoring, perforating, marking, etc.) a substrate, such as a sheet of a material (e.g., paper, cardstock, a polymer film, foil, fabric, etc.) at a plurality of laterally discrete, substantially linear, substantially parallel locations. Methods for simultaneously modifying a substrate at a plurality of laterally discrete, substantially linear, substantially parallel locations are also disclosed.

### RELATED ART

A variety of tools are available for cutting, scoring, perforating, and/or marking substrates, such as sheets of paper, cardstock, plastic films, foils, fabrics, and other materials. Existing tools, particularly paper trimmers, are capable of forming only one cut, score line, or perforation in a substrate or one mark on a substrate at a time. Thus, a plurality of cuts, score lines, perforations, or marks can only be formed in a substrate by using such an existing tool a plurality of times, in sequence. Moreover, different tools are typically required to make different types of modifications to a substrate. Repeated use of one or more existing tools to cut, score, perforate, and/or mark substrates is time-consuming, and can become tiresome to an individual (e.g., a craft enthusiast, a hobby enthusiast, etc.).

### SUMMARY

An apparatus according to this disclosure is capable of interacting with and simultaneously making a plurality of modifications to a substrate, such as a sheet of a material (e.g., paper, cardstock, a polymer film, foil, fabric, etc.), at a plurality of laterally discrete, substantially linear, substantially parallel locations. Such an apparatus may include a base for supporting a substrate and a handle for causing a plurality of tools to simultaneously, or concurrently, interact with a substrate that has been placed on the base and for moving the tools at least partially across the substrate.

The base of the apparatus may include a surface that is capable of supporting a substrate. Such a surface may be substantially planar. The surface of the base may be capable of substantially retaining its appearance after the apparatus has been used to modify a substrate. Alternatively, the surface of the base may be capable of self-healing, or of substantially returning to its previous appearance after a substrate supported by the surface has been modified. In some embodiments, the surface may include gridlines, which may be used to facilitate alignment of a substrate and to enable the precise placement of a substrate on the surface. The gridlines may be spaced apart from one another at equal intervals, which may enable use of the gridlines for measuring distance. Indicia, such as numbers, that correspond to distance measurements may also be provided on or adjacent to the surface of the base.

In some embodiments, a surface that is capable of supporting a substrate may comprise part of an element, such as a mat or a panel, that is removable from a remainder of the base. Such an element may be removably received by a recess, or a receptacle, of the base, enabling an individual to flip the element or to replace the element once repeated use of the apparatus has worn the surface or rendered it unsightly.

The handle of the apparatus may mutually engage the base in a manner that enables the handle to be translated, or moved, at least partially across the surface of the base (and at least partially across any substrate that has been placed on the surface). A plurality of tools may be carried at a variety of laterally discrete, spaced apart locations across the handle.

Each tool may include a coupling element and a modification element. The coupling element of each tool may couple the tool to the handle of the apparatus. Without limitation, the coupling element may be capable of receipt by a tool receptacle of the handle (e.g., the coupling element may comprise a pin, a rod, or the like). In some embodiments, the coupling element of each tool and/or each tool receptacle of the handle may have a configuration capable of ensuring that the tool will align with its direction of travel as the handle is translated at least partially across the surface of the base and at least partially across a substrate supported by the surface of the base. The coupling element of each tool engage or be engaged by each receptacle of the handle in a manner that ensures that each tool will remain in place as the handle is translated at least partially across the surface of the base and at least partially across any substrate supported by the surface of the base.

The modification element of each tool may be capable of modifying a substrate as it contacts the substrate or is forced against the substrate. Various embodiments of tools that may be assembled with the handle of the apparatus include cutting blades, scoring styluses, perforating wheels, writing and/or drawing instruments (e.g., markers, pens, pencils, etc.), and other apparatuses that may modify a substrate upon contacting or being forced against the substrate.

When assembled with the handle, adjacent tools may be spaced at a variety of different distances apart from one another. Different types of tools may be assembled with the handle in a variety of different arrangements.

The handle may be capable of causing a plurality of tools that have been assembled therewith to interact with a substrate supported by the surface of the base. In some embodiments, the handle may cause the plurality of tools to interact with the substrate when the handle is translated at least partially across the surface of the base. In other embodiments, the handle may include an actuator that, when actuated, moves the tools into contact with the surface of the base or into contact with a substrate that has been placed on the surface. Use of the actuator may also enable translation of the handle and the tools at least partially across the surface of the base and any substrate on the surface.

In another aspect, methods for concurrently modifying a sheet of a material at a plurality of laterally discrete, substantially linear, substantially parallel locations are disclosed. Such a method includes selecting a plurality of tools to be used to concurrently modify the sheet of material. Selection of the plurality of tools may include selecting a plurality of tools of the same type, or selecting different two or more different types of tools. Various types of tools may be selected for use in modifying the sheet of the substrate, such as cutting blades, scoring styluses, perforating wheels, and writing and/or drawing instruments.

Once the tools have been selected, they may be selectively assembled across a handle of an apparatus capable of causing the plurality of tools to concurrently modify the sheet of material in a desired arrangement. The desired arrangement may include spacing adjacent tools a desired distance apart from one another. The desired arrangement may also include positioning different types of tools at desired locations. As an example, cutting tools may be positioned at the outside of a set of tools, with perforating tools and/or writing/drawing instruments being placed between a pair of cutting tools.

A sheet of material may be placed on a working surface of a base of the apparatus. In some embodiments, the sheet of material may be secured to the surface. In a more specific embodiment, the sheet may be adhesively secured to the surface by securing one or more adhesive elements to the surface and securing the sheet to the adhesive element(s). Alternatively, the surface may comprise a tacky material to which the sheet may adhere when the sheet is positioned on the surface. Other techniques for securing the sheet to the surface may also be employed.

With the sheet of material on the working surface, the tools may be brought into contact with the sheet of the material and the handle may be translated (e.g., manually, by way of a drive system (e.g., a drive system operated by a hand crank, a drive system operated by a motor, an automated drive system, etc.), etc.) to force the tools at least partially across the sheet of the material. The tools may contact and be forced against the surface of the base and any sheet of material on the surface simply by translating the handle at least partially across the surface. Alternatively, the tools may be lowered into contact with the surface, and then moved across the surface and any sheet of material thereon by translating the handle at least partially across the surface.

In another aspect, a tool that can be used with the apparatus of this disclosure may also be used with a hand-held and hand-operated handle. Such a handle may include a single tool receptacle for removably receiving a coupling element of a single tool. The handle may enable an individual to use the tool to modify a sheet of material with the assistance of a straight edge, another guide, or without the assistance of a guide (i.e., by freehand).

Other aspects, as well as features and advantages of various aspects of the disclosed subject matter, will become apparent to those of ordinary skill in the art through consideration of the ensuing description, the accompanying drawings, and the appended claims.

### BRIEF DESCRIPTION OF THE DRAWINGS

In the drawings:

FIG. 1 is a perspective view of an embodiment of an apparatus that is capable of interacting with and simultaneously making a plurality of modifications to a substrate;

FIG. 2 is a perspective view of a base of the embodiment of apparatus shown in FIG. 1;

FIGS. 3A-3C provide top, side, and perspective views, respectively, of the handle of the embodiment of apparatus shown in FIG. 1;

FIG. 4 provides a perspective view of the embodiment of apparatus shown in FIG. 1, with a portion of the handle and base having been cut away to illustrate features of the handle and an arrangement of those features with the base of the apparatus;

FIG. 5 provides an inverted perspective view of an embodiment of the carriage shown in FIG. 4, with a portion of the carriage having been cut away to illustrate a manner in which the tools may be received by tool receptacles of the carriage and, thus, of the handle of the embodiment of apparatus shown in FIGS. 1-4;

FIGS. 6A and 6B are top and side views, respectively, of the embodiment of carriage shown in FIG. 5;

FIGS. 7A-7L depict various embodiments of tools and, more specifically, various embodiments of modification elements of tools that may be used with an embodiment of an apparatus according to this disclosure;

FIGS. 8A-8D are various view of an embodiment of a device capable of coupling and uncoupling tools to the carriage of the handle of an apparatus such as that shown in FIG. 1 or to a handle of the type shown in FIG. 13;

FIGS. 9A-9D are various views of another embodiment of a carriage that may be used with a handle of an apparatus according to this disclosure;

FIG. 10 is another perspective view of the embodiment of apparatus shown in FIG. 1, depicting an embodiment of a manner in which a carriage for tools of the apparatus may be removed from and replaced in the handle of the apparatus;

FIGS. 11A-11D are various views of an embodiment of an access door of the handle of the embodiment of apparatus shown in FIG. 1, which may be opened to provide access to a slot capable of receiving and aligning the embodiments of carriages shown in FIGS. 5, 6A, 6B, and 9A-9D;

FIGS. 11E-11H are various view of an embodiment of a carriage receptacle within a handle of the apparatus;

FIGS. 12A-12D are various views of an embodiment of an actuator of the handle of the embodiment of apparatus shown in FIG. 1;

FIG. 13 illustrates an embodiment of an apparatus that is capable of interacting with and simultaneously making a plurality of modifications to a substrate, which embodiment includes a drive system for translating a handle of the apparatus at least partially across a base of the apparatus; and

FIG. 14 depicts a handle that is capable of being held within an individual's hand and that may be used to hold and manipulate a single tool, such as any of those shown in FIGS. 7A-7L.

### DETAILED DESCRIPTION

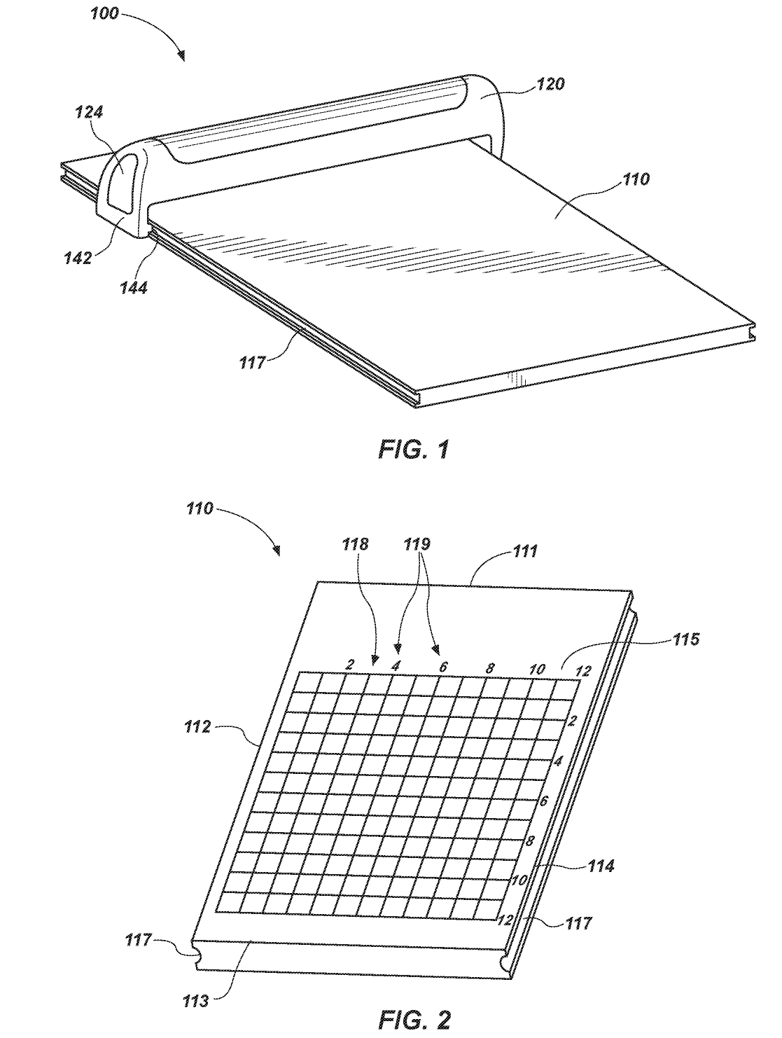

FIG. 1 depicts an embodiment of an apparatus 100 that includes a plurality of tools (not shown in FIG. 1) that are capable of being used be simultaneously to define a plurality of cuts, perforation lines, and/or score lines in a substrate. The apparatus 100 includes a base 110 and a handle 120 above the base 110. The handle 120 is capable of sliding between a location at or adjacent to one peripheral edge 111 of the base 110 (e.g., a rear edge of the base 110, etc.) and another location at or adjacent to an opposite peripheral edge 113 of the base 110 (e.g., a front edge of the base 110, etc.). As will be described in further detail hereinafter, the handle 120 is capable of carrying the plurality of tools that can cutting, perforating, and/or score a substrate supported by the base 110 of the apparatus 100.

As shown in FIG. 2, in addition to including peripheral edges 111, 112, 113, and 114, the base 110 includes a surface 115 within a boundary defined by, or within the confines of, the peripheral edges 111, 112, 113, and 114. As illustrated, the surface 115 may comprise a top surface of the base 110. Thus, the surface 115 may also be referred to as a “top surface.” The surface 115 is capable of supporting a substrate (not shown in FIG. 2). Accordingly, the surface 115 may also be referred to as a “working surface” and have dimensions (e.g., 12 inches by 12 inches, 14 inches by 14 inches, 12 inches by 16 inches, 18 inches by 18 inches, etc.) that will enable it to receive substrates of a variety of conventional sizes. In addition, the surface 115 may be referred to herein as a “first surface” of the base 110 of the apparatus 100.

In addition to supporting a substrate, the surface 115 of the base 110 of the apparatus 100 may be capable of engaging the substrate. In some embodiments, a material from which the surface 115 is formed may attract a material from which the substrate is formed. As an example, one or both of the material of the substrate and the material from which the surface 115 is formed may electrostatically attract the other. In other embodiments, the material from which the surface 115 is formed may adhere to a material from which the substrate is formed. Such a material may comprise an adhesive component (e.g., it may be tacky, etc.).

As an alternative to a surface 115 to which a substrate is attracted and/or adheres, the apparatus 100 may include replaceable adhesive elements (not shown), which may be placed on the surface 115 to secure a substrate to the surface 115. Such a replaceable adhesive element may be thin and flat, with adhesive material (e.g., a pressure sensitive adhesive material, etc.) on opposite surfaces thereof, enabling one surface of the adhesive element to adhere to the surface 115, while the opposite surface of the adhesive element may receive and adhere to a substrate. Such an adhesive material may hold a substrate in place while being readily removable from the substrate without damaging the substrate and without leaving a substantially residue on the substrate (e.g., without rendering any part of the substrate discernably tacky to an individual's touch, as small amounts of the adhesive material may be transferred to the substrate). An example of such an adhesive material is the adhesive material marketed by 3M of St. Paul, Minn. as SCOTCH® Restickable Glue. In embodiments where replaceable adhesive elements are used with the apparatus 100, each replaceable adhesive element may be used on surface 115 at least once and, optionally, for as long as the adhesive material on the replaceable adhesive element is capable of effectively securing a substrate in place relative to the surface 115.

The surface 115 may be formed from a material that is capable of absorbing the forces that will be applied thereto by various tools, such as the blades of cutting tools and/or scoring tools and the pins of perforating tools. In some embodiments, the material from which the surface 115 is formed may enable the surface 115 to substantially retain its appearance following use of one or more tools (not shown in FIG. 2) carried by the handle 120 (FIG. 1) of the apparatus 100 on a substrate that has been placed on and is supported by the surface 115. In other embodiments, the surface 115 may be formed from a so-called “self-healing” material, which may enable the surface 115 to substantially return to its previous appearance; i.e., its appearance before cutting, perforating, scoring, etc., a substrate that has been placed on and is supported by the surface 115. In either of these embodiments, as well as in other embodiments, the surface 115 may wear with repeated use of the apparatus 100.

The surface 115 of the base 110 of the apparatus 100 may be defined at least in part by a mat (not shown), which may be removed from, or disassembled from, a remainder of the base 110 and replaced with another mat, which may be assembled with the base 110. More specifically, a removable, replaceable mat that defines the surface 115 may be received within a recess, or a receptacle, (not shown) in the base 110 and laterally retained by edges of the recess. Alternatively, the surface 115 may comprise a permanent surface of the base 110 of the apparatus 100.

In the embodiment illustrated by FIGS. 1 and 2, the surface 115 of the base 110 of the apparatus 100 includes grid lines 118, which may facilitate alignment of a substrate and enable the precise placement of the substrate on the surface 115 so that tools (not shown in FIG. 1 or FIG. 2) carried by the carrier 120 (FIG. 1) will interact with desired locations on the substrate. The grid lines 118 may be positioned at a fixed distance (e.g., one-eighth inch, one-fourth inch, a half a centimeter, a centimeter, etc.) apart from one another. In addition, indicia 119 (e.g., numbers, etc.) that correspond to distance measurements (e.g., inches, centimeters, etc.) may be used in conjunction with the grid lines 118 (e.g., adjacent to at least two perpendicular peripheral edges 111, 112, 113, 114 of the base, etc.) to further enable precise placement of a substrate on the surface 115. In embodiments, where the surface 115 comprises part of a removable, replaceable mat, the indicia 119 may be included on the mat, or they may be included on a permanent portion of the base 110, adjacent to a periphery of a receptacle for the mat.

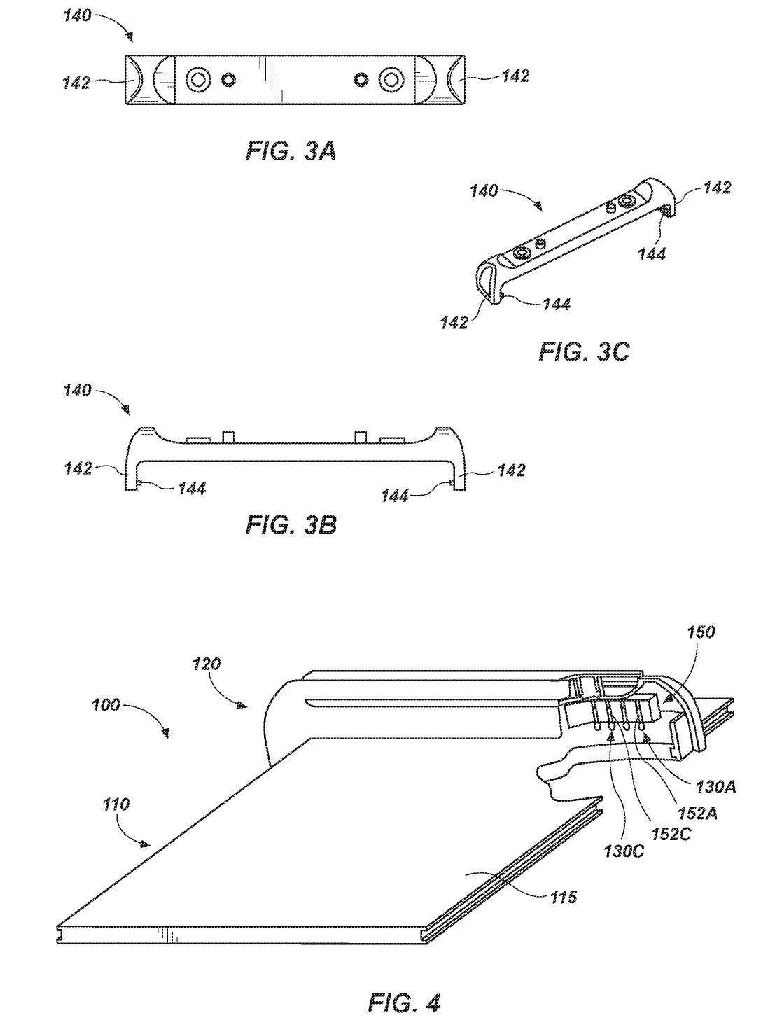

Grooves 117 may be formed in the base 110 along opposite peripheral edges 112 and 114 of the base 110. The grooves 117 may be capable of receiving corresponding, complementary features of the handle 120 (shown in FIG. 1) to enable the handle 120 to slide, to move, or to be translated at least partially across the surface 115 of the base 110. As depicted by FIGS. 3A-3C, the features that are complementary to the grooves 117 shown in FIG. 2 may comprise arms 142 on opposite sides of a body 140 of the handle 120 (FIG. 1). In the orientation illustrated by FIGS. 3A-3C, the arms 142 protrude downwardly from the body 140 of the handle 120. Each arm 142 may include a groove engagement feature 144, such as one or more lateral protrusions, that may be received by and engage a corresponding groove 117 formed in the base 110 of the apparatus 100.

Turning now to FIG. 4, the handle 120 of the apparatus 100 is capable of holding a carriage 150, which, in turn, includes a plurality of tool receptacles 152A, 152B, 152C, etc., that are capable of receiving and aligning a plurality of tools 130A, 130B, 130C, etc. The tools 130A, 130B, 130C, etc., may be interchangeable with one another; that is, each tool 130A, 130B, 130C, etc., may be removed from a tool receptacle 152A, 152B, 152C, etc., and replaced with another tool 130A, 130B, 130C, etc. As one of ordinary skill in the art will appreciate from viewing FIG. 4, as the handle 120 moves, the tools 130A, 130B, 130C, etc., also move. Thus, as the handle 120 is translated at least partially across the surface 115 of the base 110, the tools 130A, 130B, 130C, etc., are also translated at least partially across the surface 115 of the base 110.

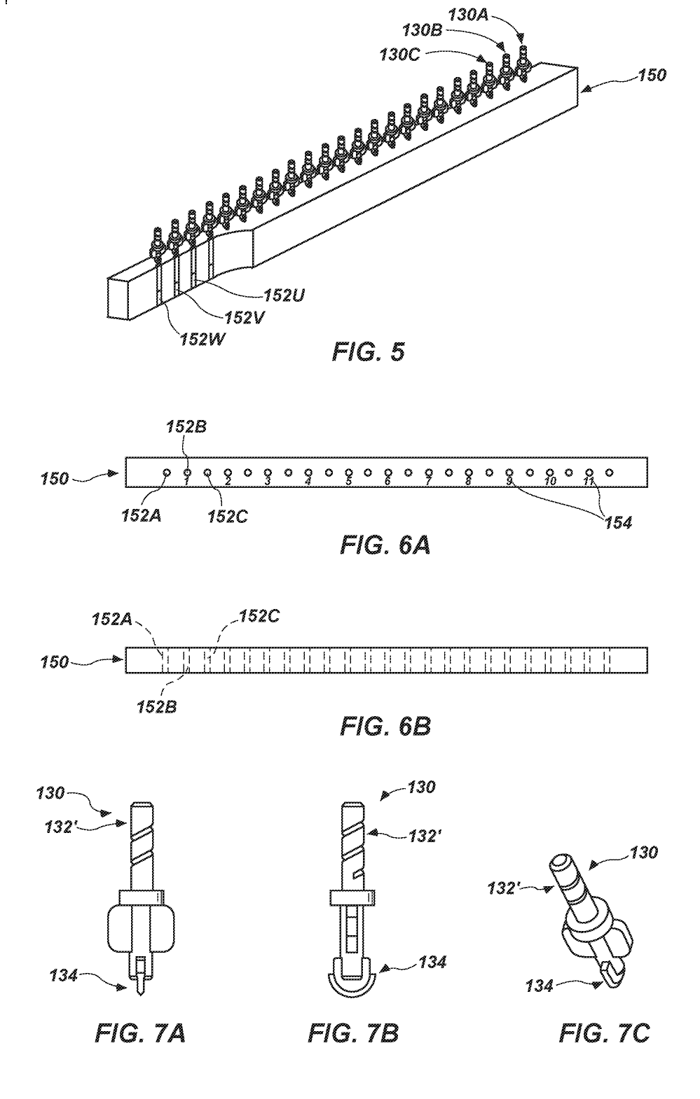

An embodiment of the carriage 150 is shown in greater detail in FIGS. 5, 6A and 6B. The carriage 150 may comprise an elongated block having a plurality of predefined holes, or tool receptacles 152A, 152B, 152C, etc., each of which may be referred to as a “tool receptacle 152” for the sake of simplicity. Each tool receptacle 152 is capable of receiving a tool 130A, 130B, 130C, etc. The tool receptacles 152 may be arranged and, thus, spaced apart from one another at fixed distance increments (e.g., one-fourth of an inch, one-half of an inch, 5 mm, 1 cm, etc.). Each tool receptacle 152 may extend at least partially through a height of the carriage 150, with each tool receptacle 152 opening to surface of the carriage 150 that will face the surface 115 (FIG. 4) of the base 110 (FIG. 4) of the apparatus when the carriage 150 is assembled with the handle 120 (FIG. 4) of the apparatus 100. In some embodiments, indicia 154 (e.g., position indicia, distance measurement indicia, etc.) may be provided adjacent to an opening of each tool receptacle 152 to facilitate the arrangement of one or more tools 130A, 130B, 130C, etc., along the carriage 150.

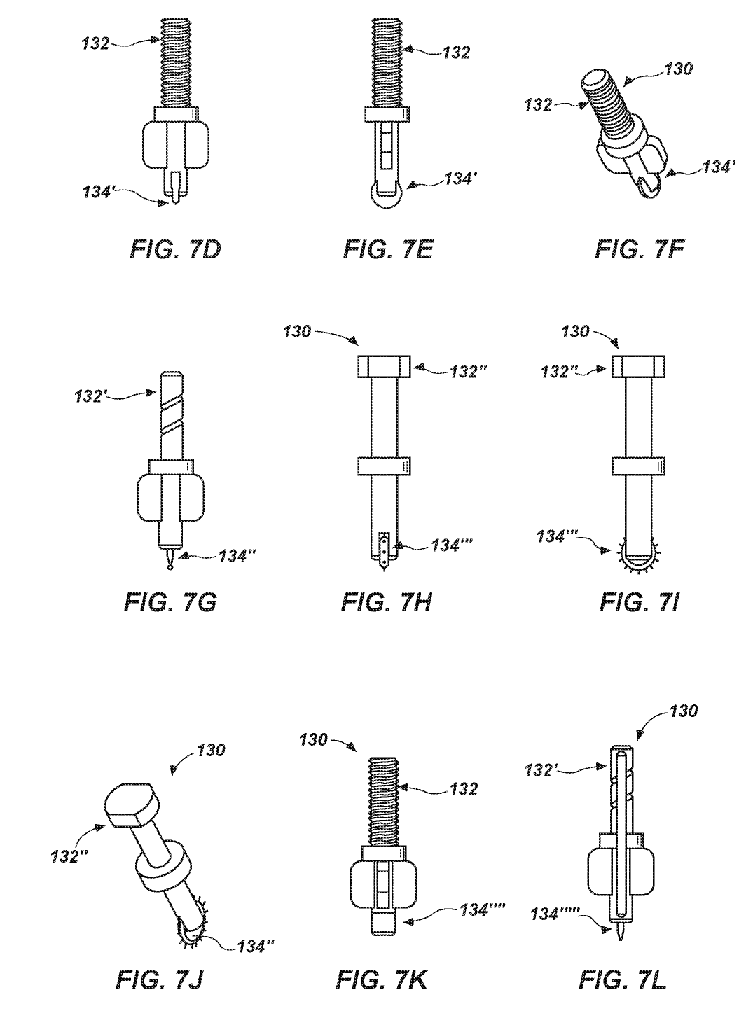

Various embodiments of tools 130A, 130B, 130C, etc., are shown in FIGS. 7A-7L. For the sake of simplicity, each tool 130A, 130B, 130C, etc., may be referred to as a “tool 130.” Each tool 130 includes a coupling element 132 (e.g., a post, a shaft, etc.) that is configured complementarily to a configuration of each tool receptacle 152 to enable each tool receptacle 152 to engage and correctly align each tool 130 or, more specifically, a modification element 134 of each tool 130. Various, embodiments of coupling elements are shown in FIGS. 7A-7L. These include, but are not limited to, threaded coupling elements 132, luer lock coupling elements 132′ and shaped coupling elements 133″ (e.g., elongated shapes with flat edges, polygonal prisms, star prisms, etc.).

The coupling elements 132 of the tools 130 can be easily inserted into and removed from the tool receptacles 152 of the carriage 150. In a specific embodiment, each coupling element 132 may be inserted into a tool receptacle 152 and twisted until the coupling element 132 “locks” into place within the tool receptacle 152. Removal of the tool 130 from the carriage may include twisting the tool 130 in the opposite direction to unlock its coupling element 132 from the tool receptacle 152, and then pulling the coupling element 132 out of the tool receptacle 152.

The modification element 134 of each tool 130 is capable of interacting with a substrate and, upon interacting with the substrate, modifying the substrate. Among the various types or embodiments of modification elements 134, 134′, 134″, etc., are cutting blades 134, cutting wheels 134′, scoring blades 134″, perforating wheels 134′″, embellishment wheels 134″″, and writing/drawing instruments 134″″′. A cutting blade 134 may be configured to cut a substrate in a straight line. A cutting wheel 134′ may have a configuration that enables it to make patterned cuts (e.g., rounded wavy cuts, squared wavy cuts, peaked cuts, scalloped cuts, zigzag cuts, rippled cuts, jigsaw cuts, deckle cuts, plaited cuts, large plinking cuts, clouding volcano cuts, skipped or dashed cuts, perforations, patterned punch-outs, etc.) in a substrate. Scoring styluses 134″, perforating wheels 134′″, and embellishment wheels 134″″ may likewise be used to make straight or patterned modifications to a substrate. A variety of different types of writing/drawing instruments 134″″′ may be used, including, without limitation, felt tip markers, gel pens, invisible ink pens, calligraphy pens, pencils, and the like. Tools with a variety of other types of modification elements 134 that can function when moved in a straight line across a substrate are also within the scope of this disclosure.

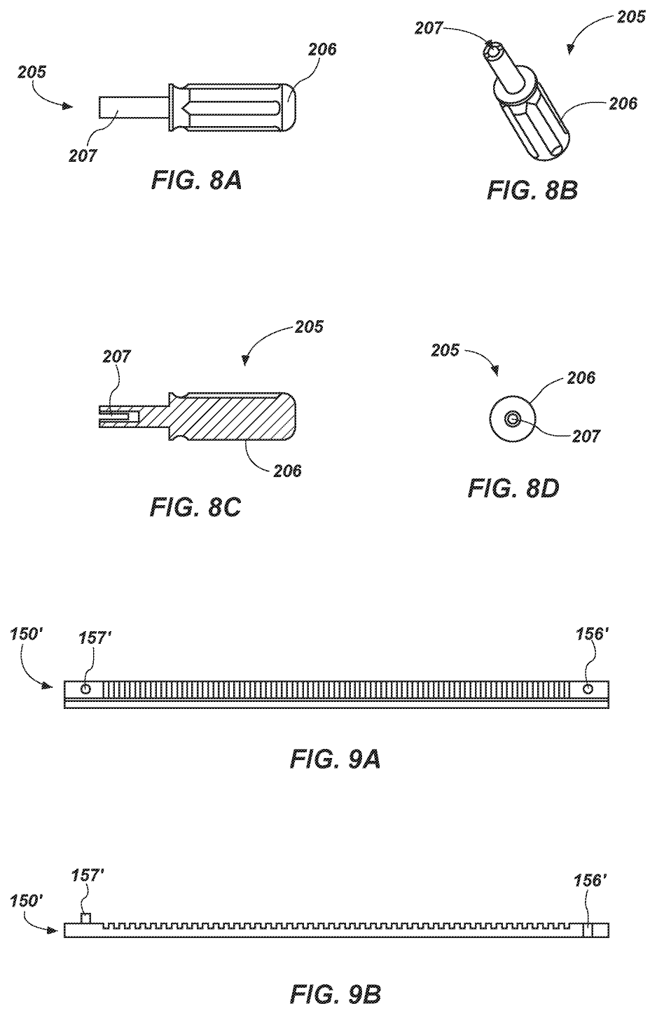

Insertion of the coupling elements 132 of the tools 130 into and removal of the coupling elements 132 of the tools 130 from the tool receptacles 152 may be facilitated by an assembly/disassembly device 205, such as that shown in FIGS. 8A-8D. The assembly/disassembly device 205 may include a handle 206 at one end and a receptacle 207 at an opposite end. The receptacle 207 may be capable of receiving the modification element 134 of the tool and engaging the modification element 134 or the coupling element 132 of the tool in a manner that enables the assembly/disassembly device 205 to twist the tool 130 without damaging it.

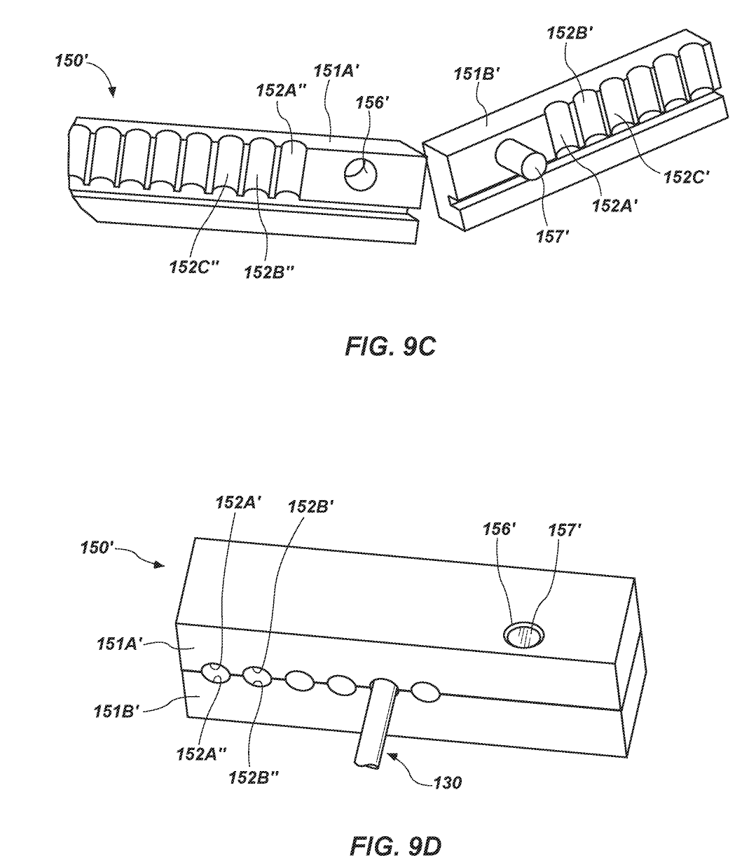

Another embodiment of carriage 150′ is shown in FIGS. 9A-9D. That embodiment of carriage 150′ includes a pair of elongated members 151A′ and 151B′. A first elongated bar 151A′ may include an engagement receptacle 156′ for receiving an engagement member 157′ protruding from the second elongated member 151B′. Each of the elongated members 151A′ and 151B′ includes a plurality of slots 152A′, 152B′, 152C′, etc., and 152A″, 152B″, 152C″, etc., that correspond to one another. Each slot 152A′, 152B′, 152C′, etc., and 152A″, 152B″, 152C″, etc., is capable of receiving a tool 130 and may (e.g., due to complementary geometries that prevent improper positioning, etc.) align the tool 130 received thereby. As the elongated bars 151A′ and 151B′ are assembled with one another, around one or more tools 130 (i.e., as each tool 130 is “sandwiched” between the elongated bars 151A′ and 151B′), corresponding slots 152A′ and 152A″, 152B′ and 152B″, 152C′ and 152C″, etc., may align with one another to define corresponding tool receptacles (not shown) of the carriage 150′ and engage any tools 130 within the tool receptacles. Such a “split” carriage 150′ may enable an individual to visualize the placement of one or more tools 130 and quickly and easily install the tools 130 on the carriage 150′. Such an embodiment may also eliminate the need for a device to install and/or remove tools 130 from the carriage 150′. In one or more embodiments, indicia (e.g., measurement values, etc.) may be included on either or each member 151A′, 151B′ of the carriage 150′ to enable an individual to confirm that one or more tools 130 have been positioned at desired locations along the carriage 150′.

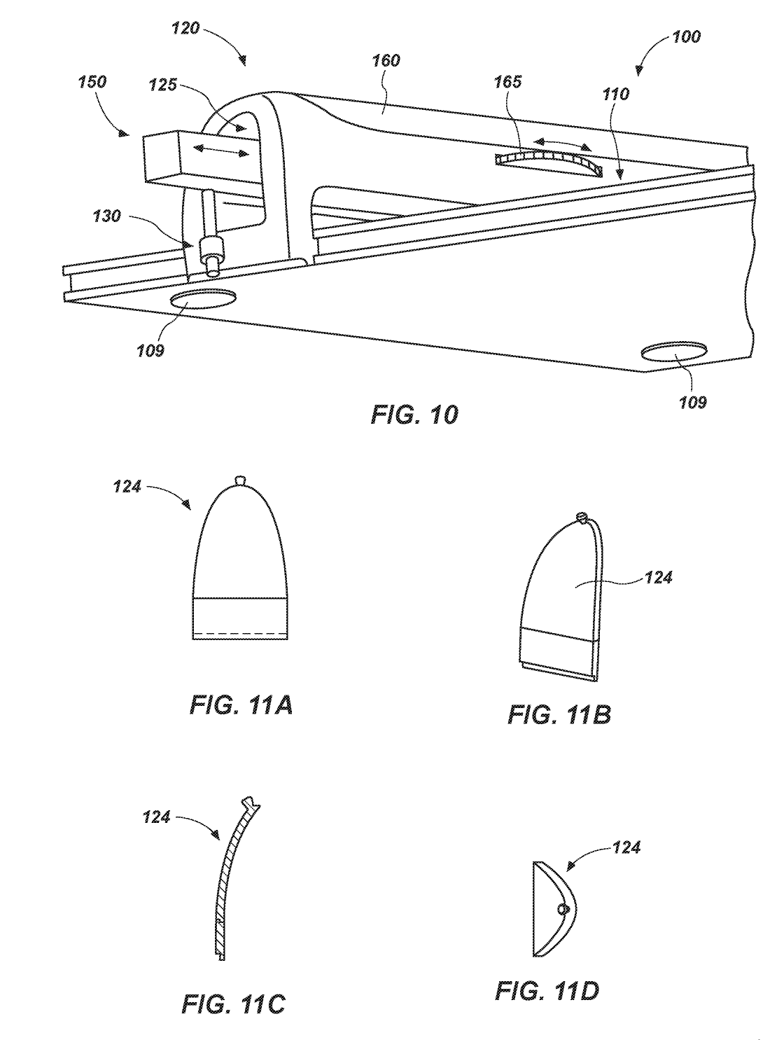

As illustrated by FIG. 10, in some embodiments, the carriage 150 may be capable of sliding out of the handle 120 to enable removal, or disassembly, of tools 130 from the carriage 150 and/or the assembly of one or more tools 130 with the carriage 150 (i.e., changing of the tools 130). Such assembly may comprise replacement of the tools 130 with another set of tools in another arrangement, rearrangement of the tools 130 that were previously coupled to the carrier 150, or the like. The handle 120 and the carriage 150 may have configurations that ensure that the carrier 150 and any tools 130 carried thereby are properly and securely aligned with a remainder of the handle 120 and with the surface 115 (FIGS. 1 and 2) of the base 110 of the apparatus 100.

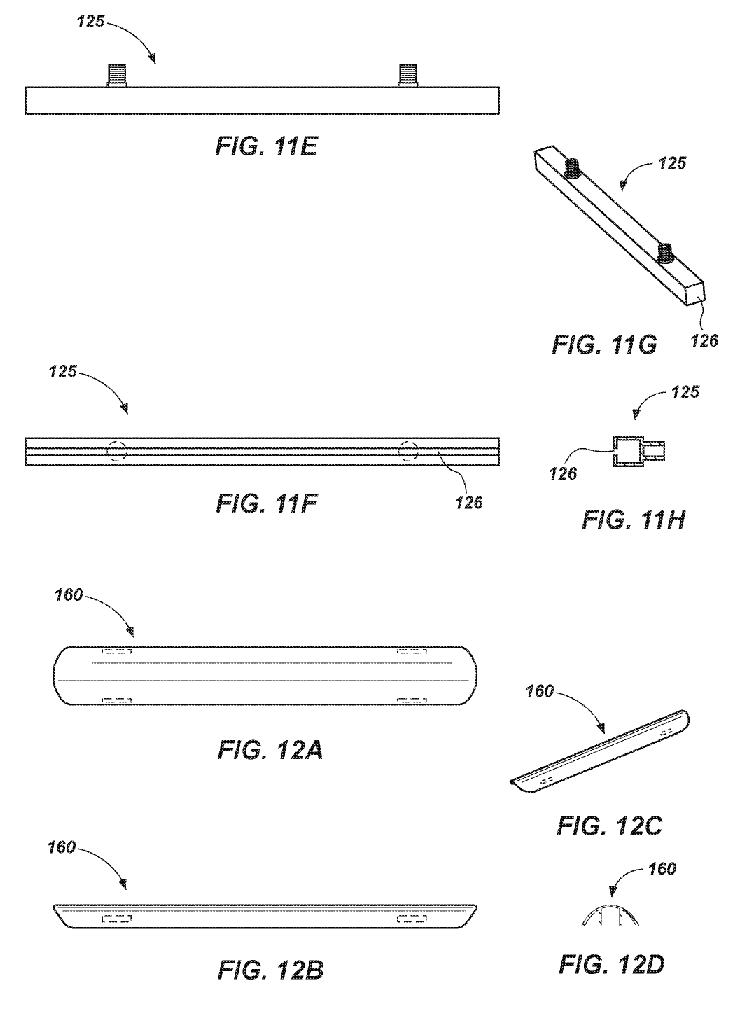

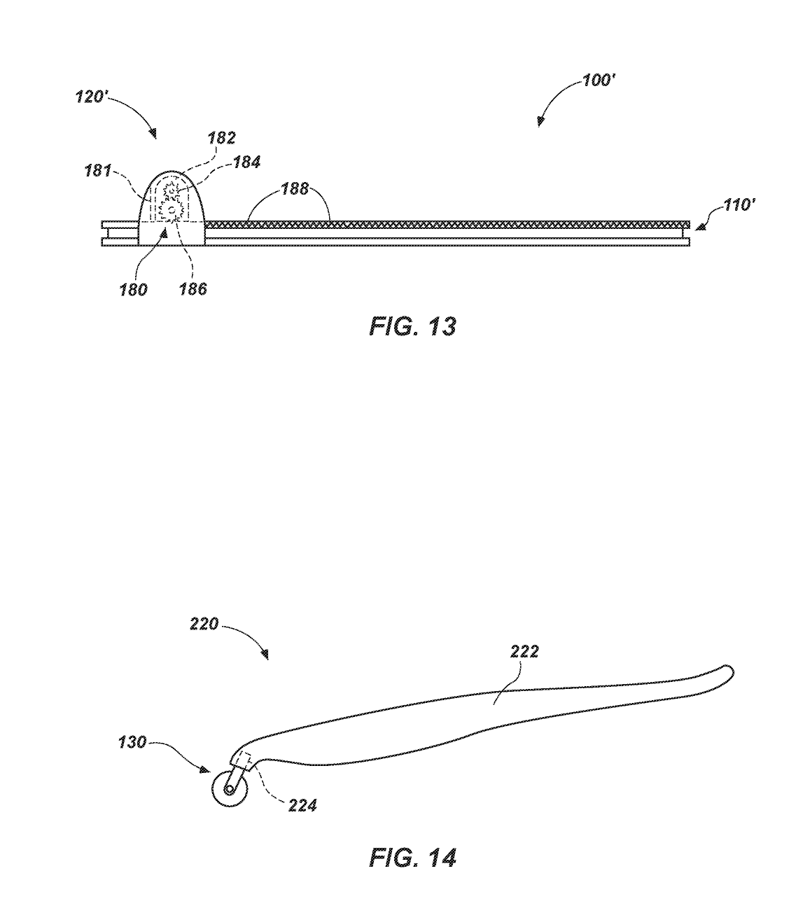

FIGS. 11A-11D illustrate an embodiment of an access door 124 of the handle 120 (FIG. 10), which may be opened to provide access to a carriage receptacle 125 (FIGS. 10 and 11E-11H) for a carriage 150 (FIGS. 5, 6A, and 6B), 150′ (FIGS. 9A-9D), etc. The access door 124 may be moved between a closed position, in which the access door 124 restricts access to the carriage receptacle 125, and an open position, in which the access door 124 provides access to the carriage receptacle 125. The carriage receptacle 125 may include an elongated slot 126 that is capable of receiving a portion of the coupling element 132 of each tool 130 that protrudes from the carriage 150 in a manner that positions the modification element 134 of each tool 130 below the carriage receptacle 125 and enables the carriage receptacle 125 to securely engage the carriage 150 without interfering with the orientation or operation of the modification element 134 of the tool 130.

With returned reference to FIG. 10, and with reference to FIGS. 12A-12D, an embodiment of an actuator 160 of the handle 120 is also shown. The actuator 160 may comprise a depressible element that, when depressed (e.g., pushed down, squeezed against the handle 120, actuated automatically (e.g., by a motor, etc.), etc.), may force the carriage 150 and any tools 130 carried by the carriage 150 downward toward or onto the surface 115 (FIGS. 1, 2, and 4) of the base 110 (FIGS. 1, 2, and 4), which may cause each tool 130 to contact or engage a substrate supported by the surface 115.

The extent to which the carriage 150 and each tool 130 carried thereby are depressed and, thus, the amount of force each tool 130 applies to a substrate on the surface 115 of the base 110 of the apparatus 100, may be controlled by control element 165. The control element 165 may be adjusted to limit the maximum distance the carriage 150 and each tool 130 carried thereby can be forced toward the surface 115 of the base 110. Optionally, the control element 165 may be adjusted to limit the distance the actuator 160 can be depressed relative to a remainder (e.g., the body 140, etc.) of the handle 120.

One or more springs (not shown) may cause the actuator 160 and the carriage 150 to return to default positions (e.g., undepressed positions, etc.) after the actuator 160 has been depressed and then released, which may cause each tool 130 to move away from the surface 115 of the base, out of contact with the surface 115 and any substrate on the surface 115.

In some embodiments, the actuator 160 may also control translation of the handle 120. For example, in embodiments where the actuator 160 comprises a depressible element, the handle 120 may remain locked in a fixed position until the actuator 160 is depressed. When the actuator 160 is depressed, the position of the handle 120 may be unlocked, which may enable movement of the handle 120 to a desired location over the base 110 of the apparatus 100.

FIG. 10 also illustrates support pads 109 on a bottom surface of the base 110 of the apparatus 110. The support pads 109 may stabilize the base and, thus, the surface 115 of the base 110. In addition, the support pads 109 may prevent the apparatus 100 from sliding on a surface that supports the apparatus 100 (e.g., a tabletop, a countertop, etc.) during use of the apparatus 100.

An apparatus 100′ according to this disclosure may include a drive system 180, which may move the handle 120′ at least partially across a surface 115′ of the base 110′. The drive system 180 may include an actuator 182, a drive gear 184 that may be rotated by the actuator 182, and a travel gear 186 that may be driven by rotation of the drive gear 184. Each of the actuator 182, the drive gear 184, and the travel gear 186 may be carried by the handle 120′ of the apparatus 110′. In addition, the drive system 180 may include a rack 188, which may extend along a peripheral edge 112′ of the base 110′. The drive gear 184, the travel gear 186, and the rack 188 may include teeth, with the teeth of each of these elements having the same pitch, thus enabling the drive gear 184 to mesh with the travel gear 186 and the travel gear 186 to mesh with the rack 188. The actuator 182 of the drive system 180 may be manually operated (e.g., it may comprise a hand crank, etc.) or it may be automated (e.g., it may comprise a motor and an associated power source 181, etc.). In some embodiments, the handle 120′ may include a drive system 180 on each side thereof, with the two drive systems 180 be capable of operating in a synchronized fashion.

In some embodiments, a base 110 of an apparatus 100 according to this disclosure may be folded, providing for convenience in packaging and storage.

Turning now to FIG. 14, an embodiment of a handle 220 that is capable of being held within an individual's hand and that may be used to hold and manipulate a single tool 130, such as any of those shown in FIGS. 7A-7L, is depicted. The handle 220 includes a grasping element 222 and a single tool receptacle 224 at an end of the grasping element 222. The grasping element 222 may be contoured and/or otherwise configured to be comfortably held by an individual's hand. The tool receptacle 224 is capable of receiving, engaging, and aligning a tool 130. The handle 220 may enable an individual to use a single tool 130 at a time to modify a substrate, either with the assistance of a guide (e.g., a straight edge, a shaped edge, a template, etc.) or in a freeform or freehand fashion.

A method for making multiple simultaneous modifications to a substrate, such as a sheet of a material, includes placing the substrate on the surface 115 of a base 110 of an apparatus 100 according to this disclosure (FIGS. 1 and 2). The substrate may optionally be secured to the surface 115 of the base 110.

In addition, with reference to FIGS. 4-9D, tools 130 may be selected and arranged in a desired manner across a carriage 150. With reference to FIGS. 10-11H, the carriage 150 may then be assembled with the handle 120 of the apparatus 100.

Thereafter, with reference to FIGS. 4 and 12A-12D, the actuator 160 of the handle 120 may optionally be depressed to bring the modification element 134 of each tool 130 into contact with the substrate. With returned reference to FIGS. 1 and 2, with each tool 130 in a position where its modification element 134 can interact with the substrate, the handle 120 may be translated at least partially across the surface 115 of the base 110 and the substrate that has been placed on the surface 115, causing the modification element 134 of each tool 130 to modify the substrate along a plurality of desired, linear or substantially linear locations along the substrate.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of embodiments of the present disclosure without limitation to the claimed subject matter.

What is claimed:

1. An apparatus for simultaneously interacting with and modifying a sheet of a material at a plurality of laterally discrete, substantially linear, substantially parallel locations, comprising:
a base including a surface capable of supporting the sheet of the material; and
a handle capable of:
being translated at least partially across the surface of the base, between a first location at or adjacent to a first peripheral edge of the base and a second location at or adjacent to a second peripheral edge of the base, the first peripheral edge and the second peripheral edge of the base being located on opposite sides of the base;
carrying a plurality of tools at a plurality of laterally discrete, spaced apart locations; and
causing the plurality of tools to contact and interact with the sheet of the material on the base while the handle is translated at least partially across the surface of the base and at least partially across the sheet of the material.

2. The apparatus of claim 1, wherein the plurality of tools includes at least one cutting blade, at least one cutting wheel, at least one scoring stylus, at least one perforating wheel, at least one embellishment wheel, and at least one writing and/or drawing instrument.

3. The apparatus of claim 1, wherein the plurality of tools may be removably positioned at a plurality of different locations across the handle.

4. The apparatus of claim 3, wherein each tool of the plurality of tools is capable of being removably positioned at locations across the handle that enable selective spacing between laterally adjacent tools of the plurality of tools.

5. The apparatus of claim 3, wherein each tool of the plurality of tools is capable of being removable positioned at locations across the handle that provide for different arrangements of tools of the plurality of tools across the handle.

6. The apparatus of claim 1, wherein the handle and each tool of the plurality of tools are capable of aligning each tool with a direction of travel of the handle and that tool during translation of the handle at least partially across the base.

7. The apparatus of claim 1, wherein the handle includes an actuator capable of causing the plurality of tools to contact and interact with the sheet of the material on the base while the handle is translated at least partially across the base and at least partially across the sheet of the material.

8. The apparatus of claim 7, wherein the actuator is capable of being depressed to lower the plurality of tools into contact with the sheet of the material on the base.

9. The apparatus of claim 1, wherein the surface of the base is formed from a self-healing material.

10. The apparatus of claim 1, wherein the surface of the base comprises a removable and replaceable working surface.

11. A tool for modifying a sheet of a material, comprising:
a coupling element capable of coupling the tool to an actuator for the tool, the pin including an alignment feature that ensures proper alignment of the tool with a plurality of different types of actuators, the plurality of different types of actuators including:
a handle capable of releasably receiving a single tool and of being held in a hand of an individual and manipulated by the hand of the individual to interact with and modify the sheet of the material; and
an apparatus capable of receiving a plurality of tools and of causing the plurality of tools to concurrently interact with and modify the sheet of the material; and
a modification element at an end of the coupling element, the modification element capable of interacting with a sheet of a material and, upon interacting with the sheet of the material, modifying the sheet of the material.

12. The tool of claim 11, wherein the modification element comprises a cutting blade, a cutting wheel, a scoring stylus, a perforating wheel, an embellishment wheel, or a writing and/or drawing instrument.

13. A method for concurrently modifying a sheet of a material at a plurality of laterally discrete, a substantially linear, substantially parallel locations, comprising:
selecting a plurality of tools to be used to concurrently modify the sheet of the material;
selectively assembling the plurality of tools in a desired arrangement across a handle of an apparatus capable of causing the plurality of tools to concurrently modify the sheet of the material;
positioning the sheet of the material on a working surface of a base of the apparatus;
causing the plurality of tools to contact the sheet of the material on the working surface; and
translating the handle and the plurality of tools at least partially across the sheet of the material.

14. The method of claim 13, wherein selecting the plurality of tools comprises selecting a plurality of tools of a same type.

15. The method of claim 13, wherein selecting the plurality of tools comprises selecting a plurality of tools of different types.

16. The method of claim 15, wherein selecting the plurality of tools comprises selecting at least two different tools from a group comprising a cutting blade, a cutting wheel, a scoring stylus, a perforating wheel, an embellishment wheel, and a writing and/or drawing instrument.

17. The method of claim 15, wherein selectively assembling the plurality of tools in the desired arrangement comprises selectively positioning the tools of different types in the desired arrangement.

18. The method of claim 13, wherein selectively assembling the plurality of tools in the desired arrangement comprises selectively spacing adjacent tools of the plurality of tools a desired distance apart from one another.

19. The method of claim 13, wherein positioning the sheet of the material on the working surface of the base of the apparatus comprises securing the sheet of the material to the working surface.

20. The method of claim 13, wherein securing the sheet of the material to the working surface includes:
adhering an adhesive element to the working surface; and
adhering the sheet of the material to the adhesive element.

21. The method of claim 13, wherein causing the plurality of tools to contact the sheet of the material comprises translating the handle and the plurality of tools at least partially across the sheet of the material on the working surface.

22. The method of claim 13, wherein causing the plurality of tools to contact the sheet of the material comprises lowering the plurality of tools onto the working surface and/or onto the sheet of the material.

23. The method of claim 13, wherein translating the handle and the plurality of tools at least partially across the sheet of the material comprises manually sliding the handle.
